(19) United States
(12) Patent Application Publication
(10) Pub. No.: US 2008/0319835 A1
(43) Pub. Date: Dec. 25, 2008

(54) Information system and information processing apparatus

(75) Inventor: Katsuhisa Tsuji, Hoi-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/213,258

(22) Filed: Jun. 17, 2008

(30) Foreign Application Priority Data
Jun. 21, 2007 (JP) 2007-163969

(51) Int. Cl. G06F 17/30

(52) U.S. Cl. 705/10

(57) ABSTRACT

An information system capable of analyzing customer interests in unpurchased commodities is provided. The information system specifies a commodity shelf or a commodity of interest to a customer based on information captured by a camera group independently of whether the customer purchases the commodity. The information system immediately displays the specified commodity shelf or commodity on a display apparatus in association with customer information. Before the customer purchases a commodity, a sales assistant can effectively identify the customer and the commodity shelf or commodity of interest and promote the sale of the commodity.

### CROSS REFERENCE TO RELATED APPLICATIONS

The present application is based on and claims priority to Japanese Patent Application No. JP 2007 163969, filed on Jun. 21, 2007 the entire contents of which are incorporated herein by reference.

### BACKGROUND OF THE INVENTION

1. Field of the Invention

The present invention is related to an information system that can analyze buying behavior of a customer.

2. Description of Background Art

Conventionally, an employee recognizes buying behavior of the customer by conversing with a customer and observing customer behavior such as how the customer examines commodities. By observing the customer behavior, aspects of the purchase, commodity layout, and sales promotion can be optimized.

In recent years, shopping stores have become large-sized and, in many cases, one store can carry various types of commodities. At the same time, elevated labor costs make it difficult to deploy many employees in the store. Accordingly, the technique of observing customer behavior by employees has become difficult.

Many techniques have been proposed for analyzing the buying behavior of the customer using a computer system. For example, the sales promotion support system described in JP-2005-309951 A can be used to acquire customer information such as movement locations and purchase information at the point of sale of the commodity. Based on a result, the system can analyze buying behavior of the customer. Such a system can be used to clarify the relation between customer movement and the location where the purchased commodity was displayed and can thereby help determine an effective commodity layout.

However, the sales promotion system described in JP-2005-309951 A is oriented toward analyzing movement and location factors associated with purchased commodities only and cannot analyze such factors associated with commodities that are not purchased.

### SUMMARY OF THE INVENTION

Generally, customers may decide on the purchase of commodities during the first visit to a given store or after several visits. In the event purchase decisions are made after several visits, commodities that may be of interest to a customer can be specified before a purchase decision is made. When it is possible to identify such commodities that may be of interest, the store can, for example, promote a sale by sending direct mail concerning the commodities of interest and encourage the customers to visit the store during the sale. Further, the store may specify a commodity of interest to a customer while he or she is visiting the store. The store can immediately promote the sale of the commodity and encourage the purchase for not only the next visit but also the current visit.

The present invention has been made in consideration of the foregoing. It is an object of the invention to provide an information system that can analyze customer interest in unpurchased commodities

An information system in accordance with an exemplary embodiment includes a customer information acquisition means for acquiring customer information, a photographic means for photographing a store inside, a customer interest specification means for associating the customer information with a customer image and thereafter specifying a commodity shelf or a commodity of interest to the customer from a customer image photographed by the photographic means, and a first output means for outputting information about a commodity shelf or a commodity specified by the customer interest specification means and the customer information about a customer interested in the commodity shelf or the commodity in association with each other.

The information system outputs information about commodity shelves or commodities of interest to a customer independently of whether the customer purchases a commodity. Before the customer purchases a commodity, it is possible to effectively promote the sale of the commodity. The store can promptly specify a commodity of interest to a customer while the customer is visiting the store. The store can also immediately promote the sale of the commodity and encourage the purchase of the commodity for not only the next visit but also the current visit.

For example, the customer interest specification means may specify a candidate for a commodity shelf or a commodity of interest to a customer when the commodity shelf or the commodity is available near a location where the customer stays for a specified time. The term candidate refers to possible commodity shelves or commodities based, for example, on locations. Other methods may be used to specify a commodity shelf or a commodity of interest to the customer from the specified candidates.

Generally, an interest degree can be correlated with a staying time duration for a particular location. The information system can specify an interest object based on the staying time duration of the customer and more accurately specify the customer interest.

The customer interest specification means may specify an eye direction of the customer according to a video captured by the photographic means and assumes a commodity shelf or a commodity of interest to the customer when the commodity shelf or the commodity is found along the eye direction.

Generally, a person tends to look at an object of interest. Therefore, the information system can more accurately specify the object of interest to the customer based on eye direction.

A commodity in a store may be provided with an identifier such as a bar code label that can identify the commodity. If such an identifier is provided, the customer interest specification means may extract the identifier associated with a commodity picked up by a customer from a video captured by the photographic means and specify the commodity identified by the extracted identifier as a commodity of interest to the customer.

The first output means outputs information about a commodity shelf or a commodity specified by the customer interest specification means and customer information about a customer that has shown interest in the commodity shelf or the commodity. The information may be stored in the storage means.

By collecting the customer information and the information about the commodity shelf or commodity of interest, it is possible to analyze interests and trends of customers over a long period of time in terms of customer information and the information specified by the customer interest specification means.

The information system may be constructed to include a revisit determination means for determining a revisit of a customer based on the customer information acquired by the customer information acquisition means and the customer information stored in the storage means. When the revisit determination means determines a revisit of a customer, the first output means may further output information stored in the storage information, that is, information about a commodity shelf or a commodity of interest to the customer in association with customer information about the customer.

Using the output provided by such a system, a sales assistant in the store can promptly comprehend commodity shelves or commodities that were of interest to the customer during previous visits to the store. The sales assistant can inform the customer of the commodity location.

The first output means may output only the information about a commodity shelf or a commodity specified by the customer interest specification means and the customer information about a customer interested in the commodity shelf or the commodity. Further, the first output means may partially output an image of the customer photographed by the photographic means in addition to the information about the commodity shelf or commodity or the customer information. It is thereby possible to make a correspondence between the information output by the first output means and a customer who is actually in the store.

In other embodiments, the customer information acquisition means may acquire the customer information about a visiting customer from a storage apparatus owned by a customer and may store the customer information. The information system may further include a second output means for outputting information about a commodity shelf or a commodity specified by the customer interest specification means and for outputting the customer information about a customer interested in the commodity shelf or the commodity to the storage apparatus in association with each other. Such an information system can allow the customer to receive seamless service in different stores.

In accordance with still other embodiments, a single information processing apparatus can be constructed including the customer interest specification means and the first output means. An information processing apparatus according to such a construction provides above-mentioned effects in combination with apparatuses having the customer information acquisition means and the photographic means.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a block diagram illustrating a construction of an exemplary information system according to an embodiment;

FIG. 2 is a flow chart illustrating an exemplary store terminal process;

FIG. 3 is a flow chart illustrating an exemplary portable terminal process;

FIG. 4 is a flow chart illustrating an exemplary center server process;

FIG. 5A is diagram illustrating exemplary customer information;

FIG. 5B is diagram illustrating exemplary commodity shelf interest information;

FIG. 5C is diagram illustrating exemplary commodity interest information; and

FIG. 6 is diagram illustrating exemplary output.

### DETAILED DESCRIPTION OF THE EXEMPLARY EMBODIMENTS

Embodiments of the present invention will be described in further detail with reference to the accompanying drawings. It is to be distinctly understood that the present invention is not limited thereto but may be otherwise variously embodied within the spirit and scope of the invention.

### First Embodiment

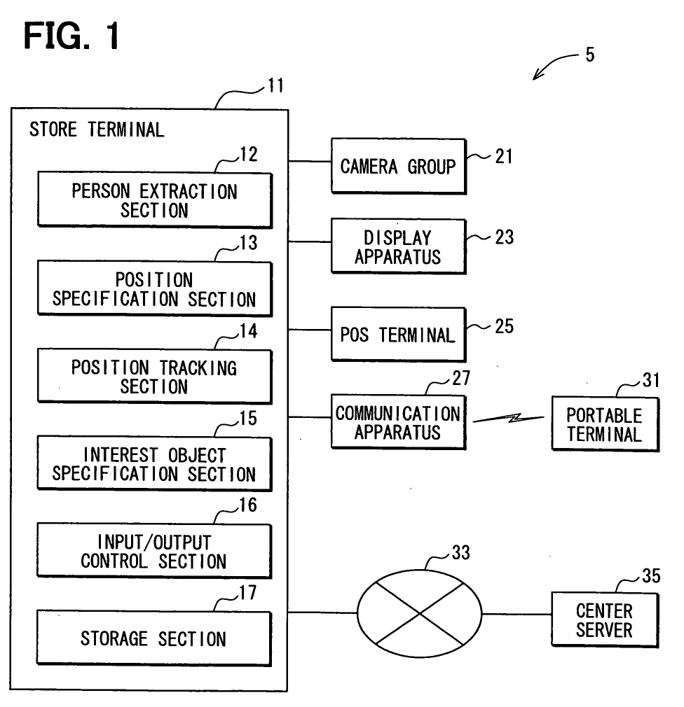

FIG. 1 is a block diagram showing an overall construction of an information system 5 in accordance with an embodiment. The information system 5 includes a store terminal 11, a camera group 21, a display apparatus 23, a point-of-sale (POS) terminal 25, a communication apparatus 27, a portable terminal 31, and a center server 35. The store terminal 11 connects with the display apparatus, the POS terminal 25, the portable terminal 31, and the center server 35. The store terminal 11 connects with the portable terminal 31 via the communication apparatus 27. The store terminal 11 connects with the center server 35 via a public communication network 33.

The store terminal 11 includes a person extraction section 12, a position specification section 13, a position tracking section 14, an interest object specification section 15, an I/O control section 16, and a storage section 17 that can be used to store data. Each of these sections includes a known central processing unit (CPU), read only memory (ROM), random access memory (RAM), input/output (I/O), hard disk, and the like and has the following functions.

The person extraction section 12 uses a known video processing technology to recognize and extract a person from a video captured by the camera group 21. When the person extraction section 12 extracts a person, the position specification section 13 specifies a position of the person in the store. The position is specified based on a picture composition of the camera and the position of the person in the video.

When the position specification section 13 specifies a person, the position tracking section 14 tracks the positions of person as they move throughout the store. That is, the position tracking section 14 provides the movement locations of the customer.

The interest object specification section 15 specifies a commodity shelf or a commodity estimated to be of interest to the person based on positions specified by the position specification section 13 and video of the person extracted by the person extraction section 12.

The I/O control section 16 communicates with the camera group 21, the display apparatus 23, the POS terminal 25, the portable terminal 31, and the center server 35. The I/O control section 16 communicates with the portable terminal 31 via the communication apparatus 27. The I/O control section 16 communicates with the center server 35 via the public communication network 33.

The camera group 21 includes multiple cameras installed so as to be able to thoroughly monitor inside the store. A video captured by the camera group 21 is input to the store terminal 11. The display apparatus 23 includes a liquid crystal panel and displays an image based on a video signal supplied from the store terminal 11. The POS terminal 25 has known POS functions and is communicable with the store terminal 11.

The communication apparatus 27 is capable of short-range radio communication with the portable terminal 31 over a distance of, for example, several meters using an antenna, corresponding to NOt shown) installed at an entry to the store.

The portable terminal 31 communicates with the store terminal 11 via the communication apparatus 27, processes and stores data. The portable terminal 31 is sized so as to be easily carried in a bag or pocket of the customer. The portable terminal 31 may be integrated with a mobile telephone or an electronic key, such as a smart key, used for driving a vehicle. The portable terminal 31 contains flash memory, corresponding to NOt shown) and stores customer information, to be described in greater detail hereinafter, in the flash memory.

The public communication network 33 represents communication networks such as Internet and ISDN lines. The center server 35 communicates with the store terminal 11 via the public communication network 33, and processes and stores data.

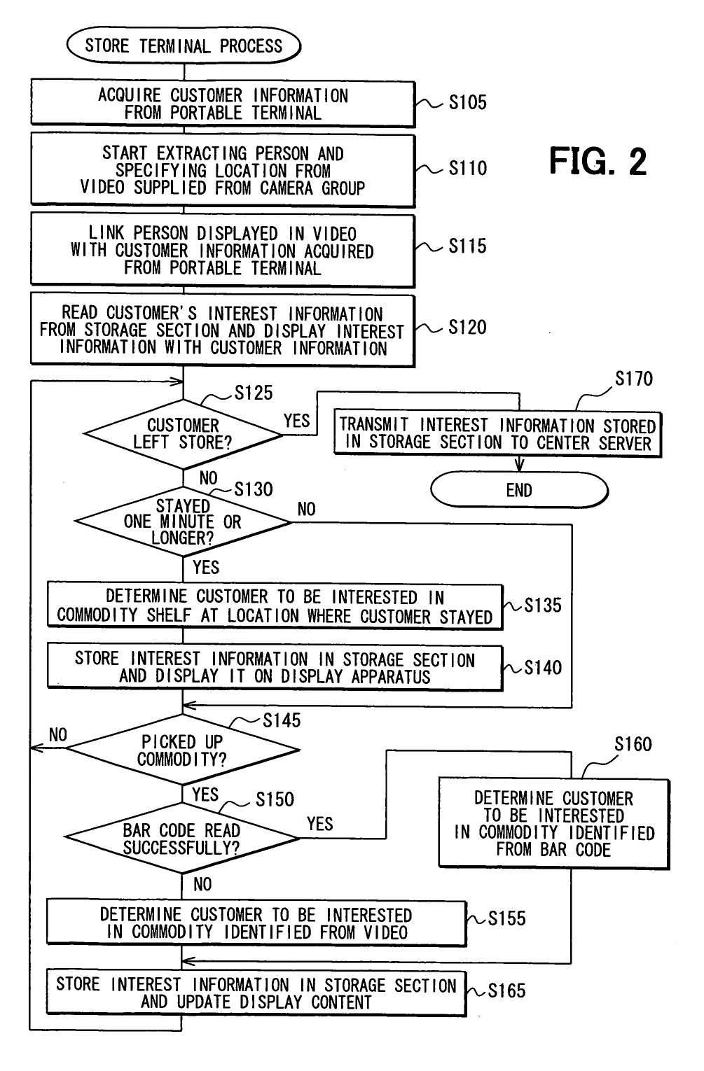

The following describes operations of the information system 5. With reference to a flow chart in FIG. 2, a store terminal process performed by the store terminal 11 starts when the store terminal 11 is ready for communication with the portable terminal 31 via the communication apparatus 27. That is, the store terminal process starts when a customer carrying the portable terminal 31 passes through a store entry or otherwise comes into communication range with the communication apparatus 27.

When the store terminal process starts, the store terminal 11 issues an instruction to the portable terminal 31 for transmitting customer information and acquires the customer information from the portable terminal 31. FIG. 5A shows the customer information. The customer information includes a group of data items such as an ID for identifying the customer, the customer name, gender, birth date, address, body height, and face image representing the customer face. The single customer information corresponds to one customer. When the portable terminal 31 stores multiple pieces of customer information, the portable terminal 31 may be configured to select the customer information about a transmission destination. The portable terminal 31 may be configured to transmit multiple elements of customer information at one time such as information about family members and the like.

Returning to FIG. 2, the store terminal 11 starts extracting a person from a video acquired from the camera group 21 and specifying and tracking positions of the extracted person. The person extraction section 12, the position specification section 13, and the position tracking section 14 function to perform the specifying and tracking process. The person specified by the specifying and tracking process will be subject to various processes to link the person in the video with the customer information as follows.

The process acquires the customer information about the person or about multiple persons at S105 while the process extracts a person or customer at S110. The store terminal 11 links the customer information acquired at S105 with the person extracted at S110 at S115. Since, for example, the process acquires the customer information about multiple persons at S105 while the process extracts one customer at S110, the process establishes a link considered to be most appropriate using information such as gender, body height, and face image contained in the customer information.

At S115, the store terminal 11 reads the interest information about the linked customer from the storage section 17. When the read succeeds, the display apparatus 23 of the store terminal 11 displays the corresponding interest information and a customer image at S120. The customer image is generally provided as an upper body half of the customer extracted from the video captured by the camera group 21. The interest information read from the storage section 17 was stored when the customer visited the store in the past. When the read fails, the process proceeds on the assumption that no information is available. Specific display examples will be described in greater detail herein after.

At S125, it is determined whether the customer leaves the store by determining, for example, whether the store terminal 11 is still ready for communication with the portable terminal 31 via the communication apparatus 27. When the customer is determined to have left the store, corresponding to YES at S125, the process proceeds to S170. When the customer is determined not to have left the store, corresponding to NO at S125, the process proceeds to S130.

At S130, the store terminal 11 determines whether the customer has stayed for one minute or longer at the same point or in the same area, such as an area measuring approximately several meters square. For example, the area can signify a space around a cart for displaying gloves or a space near a shelf for displaying hats. When the customer is determined to have stayed for one minute or longer at the same point or in the same area, corresponding to YES at S130, the process proceeds to S135. When the customer is determined not to have stayed for one minute or longer, corresponding to NO at S130, the process proceeds to S145.

At S135, the store terminal 11 determines that the customer is interested in a commodity shelf, or, more specifically, a commodity category displayed on the shelf, near or in the area. The store terminal 11 associates interest information including the information specifying the contents or commodity category of the commodity shelf with the customer, for example, via the customer information and stores the interest information in the storage section 17 at S140, and can also output the interest information to the display apparatus 23. The storage of the interest information in the storage section 17 or the output to the display apparatus 23 will be described in greater detail hereinafter.

At S145, the store terminal 11 determines whether the customer picks up or otherwise touches or handles the commodity. It will be appreciated that by using the term “picked up” reference can include picking up, touching, handling, gesturing, or the like provided that such actions can be recognized by the interest object specification section 15. Specifically, the interest object specification section 15 recognizes from the image extracted by the person extraction section 12 that the commodity has been picked up, touched or handled. When the customer is determined to have picked up the commodity, corresponding to YES at S145, the process proceeds to S150. When the customer is determined not to have picked up the commodity, corresponding to NO at S145, the process returns to S125.

At S150, a bar code attached to the commodity from the video captured by the camera group 21 is read at the store terminal 11 and it is determined whether the read is successful. It will be appreciated that the interest object specification section 15 can also functions for the determination of whether the read is successful. When the bar code reading is determined to have succeeded, corresponding to YES at S150, the process proceeds to S160. When the bar code reading is determined to have failed, corresponding to NO at S150, the process proceeds to S155.

At S160, it is determined at the store terminal 11 that the customer is interested in the commodity corresponding to the successfully read bar code. At S155, the position of the commodity shelf in which the customer has shown interest, a shape and a color of the commodity can be specified by the store terminal 11 based on the video extracted by the person extraction section 12. It can be determined that the customer is interested in the estimated commodity at the store terminal 11. For performing such an estimation, the store terminal 11 retrieves a predetermined commodity database that stores various characteristics of the commodity.

At S165, the store terminal 11 associates the interest information with the customer information and stores it in the storage section 17. The interest information includes information such as the Japanese Article Number (JAN) code, or the like, depending on the country of origin or other identifying characteristics, and the name of the commodity determined to be of interest the customer at S155 and S160. The interest information is used to update the display contents of the display apparatus 23. The process returns to S125.

The store terminal process stores the interest information in the storage section 17. At S170, the store terminal 11 transmits the stored interest information to the center server 35 via the public communication network 33. The store terminal process then terminates. The storage of interest information in the storage section 17 will be described with reference to FIGS. 5B and 5C.

FIG. 5B shows an example of the interest information stored, for example, by the store terminal 11 in the storage section 17. At S140, the store terminal 11 stores the interest information, which concerns the commodity shelf of interest to the customer and is referred to as interest information for the commodity shelf for illustrative purposes, in the storage section 17. The interest information includes a group of data such as an ID capable of identifying a customer, a date indicating the date of storage, and information capable of specifying or otherwise identifying the commodity shelf of interest at S135. The ID in the commodity shelf interest information belongs to the same system as that for the ID in the customer information. That is, the commodity shelf interest information can be linked with the customer information. The storage section 17 stores the commodity shelf interest information each time S140 is performed. Analyzing the stored information can keep track of transition of interests of a specific customer.

FIG. 5C is an example of the interest information the store terminal 11 stores in the storage section 17 at S165 as mentioned above. At S165, the store terminal 11 stores the commodity interest information in the storage section 17. The commodity information concerns the commodity of interest to the customer and is provisionally referred to as commodity interest information. It should be noted that, while discussed herein as commodity interest information and commodity shelf interest information, a more general term is “interest information” or, particularly when associated with information other than interest information, simply information, which can refer generally to commodity, commodity shelf, or other information identified to be of interest to the customer as described herein and can include the customer information or other associated information.

The information includes a group of data such as an ID capable of identifying a customer, a date indicating the date of storage, and a commodity of interest identifier, or the like, capable of specifying the commodity determined to be of interest to the customer at S155 or S160. The ID in the commodity interest information belongs to the same system as that for the ID in the customer information. That is, the commodity interest information can be linked with the customer information. The storage section 17 stores the commodity interest information each time S140 is performed. Analyzing the stored information can keep track of transition of interests of a specific customer.

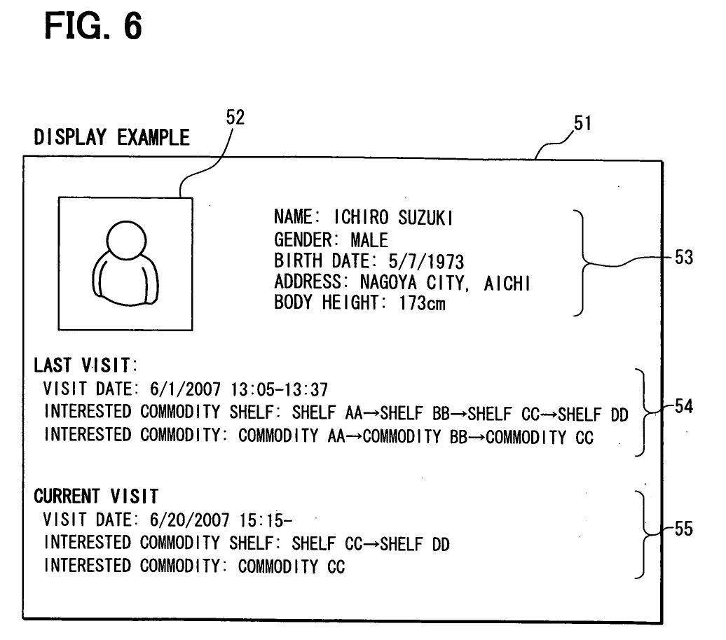

The following describes the interest information and the customer information output to the display apparatus 23 with reference to a screen example 51 in FIG. 6. The screen example 51 includes a customer picture field 52, a customer profile field 53, a past-visit interest information field 54, and a current-visit interest information field 55. The customer picture field 52 displays a still picture representing an upper half of the body of the customer extracted at S110 above. By viewing the still picture displayed in customer picture field 52, a sales assistant can easily identify which person in the store is associated with the information displayed in the other fields. The customer profile field 53 displays the customer profile based on the customer information acquired at S105 above. Referring to the profile displayed in the customer profile field 53, the sales assistant can know the name, age, and other information pertinent to identifying the customer. The past-visit interest information field 54 displays a date of the past visit to the store, transition of commodity of interest shelves, and transition of commodities of interest associated with the customer. The information is displayed based on the past-visit interest information read from the storage section 17 at S120. According to the information displayed in the past-visit interest information field 54, the sales assistant can know the information about commodity shelves which were of interest to the customer during the past visit to the store.

The current-visit interest information field 55 displays a commodity shelf determined to be of interest to the customer at S135 and a commodity determined to be of interest to the customer at S155 and S160. The current-visit interest information field 55 sequentially displays names of commodity shelves and commodities each time S135, S155, and S160 are performed. According to the information displayed in the current-visit interest information field 55, the sales assistant can immediately understand the information about commodity shelves that are of interest to the customer during the current visit and take action based on the information.

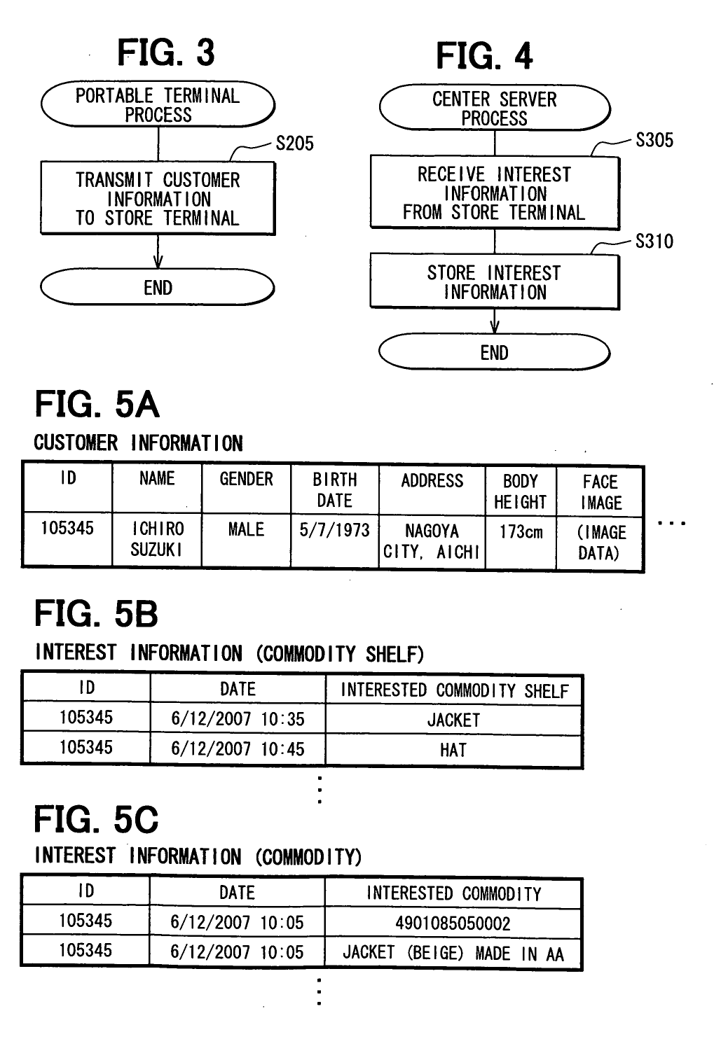

A portable terminal process performed by the portable terminal 31 will be described with reference to a flow chart as shown, for example, in FIG. 3. After the communication is enabled through the store terminal 11 and the communication apparatus 27, the portable terminal process starts upon reception of an instruction for transmitting the customer information to the store terminal 11. When the portable terminal process starts, the portable terminal 31 transmits the customer information stored locally, for example in a flash memory, to the store terminal 11 via the communication apparatus 27 at S205. The portable terminal process then terminates or can wait until re-started, or the like.

A center server process performed by the center server 35 will be described with reference to a flow chart as shown, for example, in FIG. 4. The center server process starts when the store terminal 11 transmits the interest information via the public communication network 33. When starting the center server process, the center server 35 receives the interest information transmitted from the store terminal 11 at S305. The center server 35 stores the received interest information in storage medium such as a hard disk, or the like, provided in the center server 35 at S310. The center server process then terminates or can wait until re-started, or the like.

Based on an image captured by the camera group 21, the information system 5 specifies a commodity shelf or a commodity of interest to the customer at S135, S155, and S160, independently of whether the customer purchases the commodity. The display apparatus 23 immediately displays the information about the specified commodity shelf or commodity in association with the customer information as described for example, in connection with S140, S165, and FIG. 6. Based on the displayed information, a sales assistant can effectively promote the sale of the commodity to facilitate the customer purchase.

The customer may stay at a given location for a specified time period such as one minute or longer. The system assumes a commodity shelf near that location to be of interest to the customer. The system stores information about the commodity shelf in the storage section 17 and displays the information on the display apparatus 23 at S130 through S140. The system can accurately estimate a customer interest when based on the time that the customer stays at a specific location. While the embodiment specifies only a commodity shelf, a corresponding displayed commodity may be specified in such a case that the commodity shelf displays only one commodity.

A bar code is provided for a commodity the customer picked up. The store terminal 11 extracts the bar code from a video captured by the camera group 21. The store terminal 11 specifies the commodity identified from the extracted bar code as a commodity of interest to the customer at S150. Using the bar code, or the like, the system can accurately identify a commodity of interest to the customer. The interest information and the customer information are stored in the storage section 17 at S140 and S165. Accordingly, the system can analyze long-term interests and trends of customers by analyzing the information stored in the storage section 17.

When a customer visits the store, the system attempts to read the past interest information stored in the storage section 17 to determine, for example, whether the customer previously visited the store. When the system successfully reads the past information indicating that the customer visited the store in the past, the system allows the display apparatus 23 to display the past interest information at S120.

Accordingly, a sales assistant can promptly comprehend the commodity shelves or commodities that were of interest to the customer during previous visits to the store. The sales assistant can smoothly inform the customer of the commodity location. The display apparatus 23 displays a captured image representing an upper half of the body of the customer in FIG. 6. The sales assistant can easily identify a person in the store who matches the interest information or the customer information displayed in the display apparatus 23. The interest information stored in the storage section 17 is transmitted to the center server 35 at S170. The center server 35 can analyze the received and stored information so as to analyze the long-term interests and trends of the customer.

### Other Embodiments

The store terminal process according to above-described embodiment uses a video captured by the camera group 21 to determine whether the customer picks up a commodity, for example at S145. When it is determined that the customer picks up the commodity, the process reads a bar code provided for the commodity from the video captured by the camera group 21, which specifies or otherwise identifies the commodity, for example at S150 and S1160. In accordance with other embodiments, an eye direction of the customer may be determined from a video captured by the camera group 21. When the line of vision does not move for a specified time such as, for example, ten seconds, it may be preferable to assume a commodity displayed along an extension of the line of vision to be the commodity of interest based on the relation to the shelf position. Since, generally, a person tends to look at an object of interest, it is possible to accurately specify the object interest based on eye direction.

The store terminal process according to the embodiment transmits the interest information stored in the storage section 17 to the center server 35 via the public communication network 33 at S170 when the customer is assumed to leave the store at S125. The condition of the customer leaving the store signifies that the store terminal 11 is again ready for communication with the portable terminal 31 via the communication apparatus 27. Further, the interest information stored in the storage section 17 may be transmitted to the portable terminal 31 and stored in it via the communication apparatus 27. In addition, not only the customer information but also the interest information may be acquired from the portable terminal 31 at S105. The acquired interest information may be used instead of the information read from the storage section 17 of the store terminal 11 at S120. The store terminal 11 can allow the customer to receive seamless service in different stores equipped with store terminals that are provided with the similar system.

It should lastly be noted that, in accordance with other embodiments, the communication apparatus 27 can function as a customer information acquisition means. The camera group 21 can function as a photographic means. S105 through S165 of the store terminal process performed by the store terminal 11 can function as a customer interest specification means. The I/O control section 16 of the store terminal 11 can function as first and second output means. The storage section 17 of the store terminal 11 can function as a storage means. S120 of the store terminal process performed by the store terminal 11 can function as a function as a revisit determination means. The portable terminal 31 can function as a storage apparatus. The store terminal 11 can function as an information processing apparatus.

What is claimed is:

1. An information system comprising:
a customer information acquisition means for acquiring customer information capable of identifying a customer;
a photographic means for photographing a store inside;
a customer interest specification means for associating the customer information acquired by the customer information acquisition means with a customer image photographed by the photographic means and thereafter specifying one of a commodity shelf and a commodity of interest to the customer from a customer image photographed by the photographic means; and
a first output means for outputting information about the one and the customer information in association with each other.

2. The information system of claim 1,
wherein the customer interest specification means specifies a candidate for the one when the one is available near a location where the customer stays for a specified time.

3. The information system of claim 1,
wherein the customer interest specification means specifies an eye direction of the customer according to a video captured by the photographic means and assumes the one to be of interest to the customer when the commodity shelf or the commodity is found along the eye direction.

4. The information system of claim 1,
wherein the commodity is provided with an identifier identifying the commodity; and
wherein, when the one includes the commodity, the customer interest specification means extracts the identifier when the commodity is picked up by the customer from a video captured by the photographic means and specifies the commodity as a commodity of interest to the customer based on the identifier.

5. The information system of claim 1, further comprising:
a storage means for storing information about the one specified by the customer interest specification means and the customer information about the customer interested in the one in association with each other.

6. The information system of claim 5, further comprising:
a revisit determination means for determining revisit of the customer based on the customer information acquired by the customer information acquisition means and the customer information stored in the storage means,
wherein, when the revisit determination means determines revisit of the customer, the first output means further outputs information stored in the storage information about the one and customer information about the customer in association with each other.

7. The information system of claim 1,
wherein the first output means outputs an image of the customer photographed by the photographic means in addition to the information to be output.

8. The information system of claim 1,
wherein the customer information acquisition means acquires the customer information about the customer from a storage apparatus owned by the customer and stores the customer information; and
wherein the information system further includes a second output means for outputting, to the storage apparatus, information about the one and the customer information about the customer in association with each other.
